(19) United States
(12) Patent Application Publication
(10) Pub. No.: US 2018/0010000 A1
(43) Pub. Date: Jan. 11, 2018

(54) METHOD OF IMAGE FORMATION

(71) Applicant: DataLase Ltd., Widnes Cheshire (GB)

(72) Inventors: Martin WALKER, Widnes Cheshire (GB); Anthony JARVIS, Widnes Cheshire (GB)

(21) Appl. No.: 15/536,861

(22) PCT Filed: Dec. 18, 2014
(86) PCT No.: PCT/GB2014/053755

§ 371 Date: Jun. 16, 2017

(51) Int. Cl. C09D 11/037; C01G 39/02

(52) U.S. Cl. CPC C09D 11/037; C01G 39/02; C01P 2002/88

(57) ABSTRACT

A method for providing an image on or in a substrate is provided, and comprises applying to the substrate: (i) ammonium octamolybdate (AOM) in the form of the alpha-isomer, obtainable by thermal decomposition of ammonium molybdate at 215-225° C. for 180 mins, and which has an anhydrous loss on ignition in the range 8.00 to 8.80; or (ii) a composition comprising ammonium octamolybdate as defined in (i), and a binder; followed by irradiation. Also provided are liquid ink compositions comprising AOM as defined above, and a binder.

### FIELD OF THE INVENTION

This invention relates to a method of image formation using a laser-activated marking agent.

### BACKGROUND OF THE INVENTION

Ammonium octamolybdate (AOM) is known primarily as a fire-retardant. The ability to use AOM to form an image on a substrate is disclosed in WO2002/074548.

There are several known isomeric forms of AOM, namely alpha-AOM, beta-AOM, delta-AOM and gamma-AOM and X-AOM. See U.S. Pat. No. 5,985,236 and U.S. Pat. No. 6,235,261. alpha-AOM can be made using either a wet or dry-thermal manufacturing process. Dry-thermal alpha-AOM can be prepared in a water-free environment by the calcination or thermal decomposition of ammonium dimolybdate (ADM) at high temperature. Wet alpha-AOM can be made by reacting ADM with molybdenum trioxide in an aqueous slurry, as disclosed in U.S. Pat. No. 4,762,700.

### SUMMARY OF THE INVENTION

It has been found that alpha-AOM, that has been made using a dry-thermal manufacturing process, and has a specific loss on ignition value in the range 8.00 to 8.80, is surprisingly particularly suitable for use in laser-imaging applications.

Accordingly, the invention provides a method for providing an image on or in a substrate, which comprises applying to the substrate
(i) ammonium octamolybdate in the form of the alpha-isomer, obtainable by thermal decomposition of ammonium molybdate at 215-225° C. for 180 mins, and which has an anhydrous loss on ignition in the range 8.00 to 8.80;or
(ii) a composition comprising ammonium octamolybdate as defined in (i), and a binder;
   followed by irradiation of the substrate.

Also provided is a liquid ink composition for use in image formation, which comprises ammonium octamolybdate in the form of the alpha-isomer, obtainable by thermal decomposition of ammonium molybdate at 215-225° C. for 180 mins, and which has an anhydrous loss on ignition in the range 8.00 to 8.80, and a binder. For the purposes of this invention, α-AOM may be defined as obtainable (but not necessarily obtained) by thermal decomposition of ammonium molybdate at 215-225° C. for approximately 180 minutes.

### DESCRIPTION OF PREFERRED EMBODIMENTS

Loss on Ignition (LOI) is known to the skilled man as calculated by a test used in inorganic analytical chemistry and consists of strongly heating (“igniting”) a sample of the material at a specified temperature, allowing volatile substances to escape, until its mass ceases to change. LOI testing is frequently used to analyze any matter that comprises substances that can be removed by ignition/volatilization at high temperatures, for example ≧200° C., to leave a solid or ash residue of essentially non-ignitable or non-volatile matter behind. Prior to LOI testing the sample's residual moisture content is determined by typically heating it to 105° C. for between 1 to 4 hours. Matthiessen et al. in Communications in Soil Science and Plant Analysis, 36: 2561-2573, 2005; and Ball in Journal of Soil Science, Vol. 15, No. 1, 1964, describe residual moisture content determination followed by LOI testing of soil samples.

AOM is typically heated to 450° C., as taught in ‘Certain Ammonium Octamolybdate Isomers’, Inv. 337-TA-477 (January 2004), to ensure that all the ammonia and water produced upon thermal decomposition is evolved according to the equation: (NH₄)₄Mo₈O₂₆→8MoO₃+2H₂O+4NH₃. Molybdenum (VI) oxide melts at 795° C.

Typically LOI testing may be done in air, or in some other reactive or inert atmosphere. The simple test typically consists of placing a few grams of the material in a tared, pre-ignited crucible and determining its mass, placing it in a temperature-controlled furnace for a set time at 105° C. followed by cooling in a controlled (e.g. water-free, CO₂-free) atmosphere, and re-determining the mass. This gives the % H₂O or residual moisture content of the sample. This is then followed by placing the dried sample back into the temperature-controlled furnace for a set time at, in the case of AOM, 450° C. A suitable amount of time is 4 hours. The sample is then removed and cooled in a controlled (e.g. water-free, CO₂-free) atmosphere. The mass is then re-determined to obtain the % LOI.

The process may be repeated to show that mass-change is complete.

The % anhydrous loss on ignition or ‘LOD’ value is calculated as follows:

LOD=% LOI−% H₂O content

It was been found that the preferred LOD is in the range 8.00 to 8.80, more preferably 8.20 to 8.50, even more preferably 8.22 to 8.40, yet more preferably 8.24 to 8.38, and most preferably 8.30 to 8.35.

Fully stoichiometric AOM has an LOD=8.30. In general, as LOD deviates from 8.30 it becomes increasingly less suitable for use in laser-imaging applications. Once the LOD is less than 8.00 or greater than 8.80, the AOM is effectively of little commercial use in laser-imaging applications.

As LOD decreases below 8.00, the material becomes richer in molybdenum oxide species. Consequently, the AOM becomes discoloured and too reactive. This gives rise to inks and coated substrates having a highly undesirable off-white or coloured appearance which is unacceptable to customers. It also causes the ink to become unstable, causing it to discolour with time. Substrates coated with such an ink will have poor light stability and will readily discolour on exposure to background, ambient light.

Coloured backgrounds can also have an adverse effect on machine code-readability. AOM samples with an LOD<8.00 give poor results in plastics processing. Such AOM gives rise to plastic parts that are undesirably and noticeably ‘off white’ coloured. This is due to the presence of coloured molybdenum oxides present in the samples and whose concentration in AOM may increase during high temperature processing into plastic, due to the increased reactivity of the sample.

As LOD increases above 8.80, the optical density of the resultant images decreases, which can lead to a reduction in barcode readability quality and consequently increased barcode readability failures, and overall poor image aesthetics. Further, the opacity of the ink is reduced, which is undesirable for application to brown-coloured substrates such as corrugated fiberboard and cardboard, where high opacity is needed to generate good barcode readability.

Dry alpha-AOM is prepared by the thermal decomposition of ammonium dimolybdate (ADM) e.g. at 160 to 280, preferably 200 to 240, ° C., for 0.5 to 5, preferably 1 to 4, and more preferably 2.5 to 2.5, hours, via the following reaction:

4(NH₄)₂Mo₂O₇→>(NH₄)₂Mo₃O₁₀−>(NH₄)₄Mo₈O₂₆+4NH₃+2H₂O

In order to be fully converted into dry alpha-AOM, ADM is generally heated in the temperature range 215 to 225° C. for around 3 hours. Samples of dry alpha-AOM with LOD values within a specific range can be obtained by controlling the temperature and duration at which ADM is heated. Lower temperatures and/or shorter times usually result in an AOM product with a higher LOD as it will contain unreacted ADM and also possibly ammonium trimolybdate (ATM) intermediate product. Higher temperatures and/or longer times result in a lower LOD as the decomposition of AOM to molybdenum trioxide is initiated.

The preferred particle size range of the alpha-AOM is a D50 (50th) of 1.0 to 2.5 microns and a D99 (99th) of 7.5 to 15 microns.

### Binders

alpha-AOM may be formulated into a composition that preferably comprises a binder. The binder can be any suitable binder used by the ink/coatings industry. Preferably, the binder is a polymeric binder. Examples of polymeric binders are acrylic polymers, styrene polymers and hydrogenated products thereof, vinyl polymers, polyolefins and hydrogenated or epoxidized products thereof, aldehyde polymers, epoxide polymers, polyamides, polyesters, polyurethanes, sulfone-based polymers and natural polymers and derivatives thereof. The polymeric binder can also be a mixture of polymeric binders.

Acrylic polymers are polymers formed from at least one acrylic monomer or from at least one acrylic monomer and at least one styrene monomer, vinyl monomer, olefin monomer and/or maleic monomer. Examples of acrylic monomers are acrylic acid or salts thereof, acrylamide, acrylonitrile, C₁₋₆-alkyl acrylates such as ethyl acrylate, butyl acrylate or hexyl acrylate, di(C₁₋₄-alkyl-amino)C₁₋₆-alkyl acrylates such as dimethylaminoethyl acrylate or diethylaminoethyl acrylate and C₁₋₄alkyl halide adducts thereof such as dimethylaminoethyl acrylate methyl chloride, amides formed from di(C₁₋₄-alkylamino)C₁₋₆-alkylamines and acrylic acid and C₁₋₄-alkyl halide adducts thereof, methacrylic acid or salts thereof, methacrylamide, methacrylonitrile, C₁₋₆-alkyl methacrylates such as methyl methacrylate or ethyl methacrylate, di(C₁₋₄-alkylamino)C₁₋₆-alkyl methacrylates and C₁₋₄-alkyl halide adducts thereof, amides formed from di(C₁₋₄-alkylamino)C₁₋₆-alkylamines and methacrylic acid and C₁₋₄-alkyl halide adducts thereof and crosslinkers such as N,N′-methylenebisacrylamide.

Examples of styrene monomers are styrene, 4-methylstyrene and 4-vinylbiphenyl. Examples of vinyl monomers are vinyl alcohol, vinyl chloride, vinylidene chloride, vinyl isobutyl ether and vinyl acetate. Examples of olefin monomers are ethylene, propylene, butadiene and isoprene and chlorinated or fluorinated derivatives thereof such as tetrafluroethylene. Examples of maleic monomers are maleic acid, maleic anhydride and maleimide. Examples of acrylic polymers are poly(methyl methacrylate), poly(butyl methacrylate) and styrene acrylic polymers.

Styrene polymers are polymers formed from at least one styrene monomer and at least one vinyl monomer, olefin monomer and/or maleic monomer. Examples of styrene monomers, vinyl monomers, olefin monomers and maleic monomers are given above. Examples of styrene polymers are styrene butadiene styrene block polymers, styrene ethylene butadiene block polymers, styrene ethylene propylene styrene block polymers.

Vinyl polymers are polymers formed from at least one vinyl monomer or from at least one vinyl monomer and at least one olefin monomer or maleic monomer. Examples of vinyl monomers, olefin monomers and maleic monomers are given above. Examples of vinyl polymers are polyvinyl chloride and polyvinyl alcohol.

Polyolefins are polymers formed from at least one olefin monomer. Examples of olefin monomers are given above. Examples of polyolefins are polyethylene, polypropylene and polybutadiene. Aldehyde polymers are polymers formed from at least one aldehyde monomer or polymer and at least one alcohol monomer or polymer, amine monomer or polymer and/or urea monomer or polymer. Examples of aldehyde monomers are formaldehyde, furfural and butyral. Examples of alcohol monomers are phenol, cresol, resorcinol and xylenol. An example of polyalcohol is polyvinyl alcohol. Examples of amine monomers are aniline and melamine. Examples of urea monomers are urea, thiurea and dicyandiamide. An example of an aldehyde polymer is polyvinyl butyral formed from butyral and polyvinyl alcohol.

Epoxide polymers are polymers formed from at least one epoxide monomer and at least one alcohol monomer and/or amine monomer. Examples of epoxide monomers are epichlorhydrin and glycidol. Examples of alcohol monomers are phenol, cresol, resorcinol, xylenol, bisphenol A and glycol. An example of epoxide polymer is phenoxy resin, which is formed from epichlorihydrin and bisphenol A.

Polyamides are polymers formed from at least one monomer having an amide group or an amino as well as a carboxy group or from at least one monomer having two amino groups and at least one monomer having two carboxy groups. An example of a monomer having an amide group is caprolactam. An example of a diamine is 1,6-diaminohexane. Examples of dicarboxylic acids are adipic acid, terephthalic acid, isophthalic acid and 1,4-naphthalenedicarboxylic acid. Examples of polyamides are poyhexamethylene adipamide and polycaprolactam.

Polyesters are polymers formed from at least one monomer having an hydroxy as well as a carboxy group or from at least one monomer having two hydroxy groups and at least one monomer having two carboxy groups or a lactone group. An example of a monomer having a hydroxy as well as a carboxy group is adipic acid. An example of a diol is ethylene glycol. An example of a monomer having a lactone group is carprolactone. Examples of dicarboxylic acids are terephthalic acid, isophthalic acid and 1,4-naphthalenedicarboxylic acid. An example of a polyester is polyethylene terephthalate. So-called alkyd resins are also regarded as belonging to polyester polymers. Polyurethane are polymers formed from at least one diisocyanate monomer and at least one polyol monomer and/or polyamine monomer.

Examples of diisocyanate monomers are hexamethylene diisocyanate, toluene diisiocyanate and diphenyl methane diiscocyanate.

Examples of sulfone-based polymers are polyarylsulfone, polyethersulfone, polyphenyl-sulfone and polysulfone. Polysulfone is a polymer formed from 4,4-dichlorodiphenyl sulfone and bisphenol A.

Natural polymers can be a cellulose, natural rubber or gelatin. Examples of cellulose derivatives are ethyl cellulose, hydroxypropyl cellulose, nitrocellulose, cellulose acetate and cellulose propionate.

The polymeric binders are known in the art and can be produced by known methods. The polymeric binder can be also produced in situ by UV radiation of a composition comprising monomers, capable of radical polymerisation, and a UV-sensitive initiator.

Preferred polymeric binders are acrylic polymers, vinyl polymers, aldehyde polymers, epoxide polymers, polyamides, polyesters and natural polymers and derivatives thereof. More preferred polymeric binders acrylic polymers, vinyl polymers, natural polymers and derivatives thereof.

Even more preferred polymeric binders are poly(methyl methacrylate), poly(butyl methacrylate), polyvinyl alcohol and cellulose. The most preferred polymeric binder is poly(methyl methacrylate).

Further examples include ‘core-shell’ type polymers such as those comprising a styrene-acrylic acid copolymer and a styrene/ethylhexyl acrylate copolymer, a styrene/butadiene copolymer or a vinyl acetate/crotonic acid copolymer.

The binder in a liquid ink/coating system can be in the form of a solution or emulsion.

### Solvents

The composition comprising the dry α-AOM and binder can also comprise a solvent. The solvent can be water, an organic solvent or mixtures thereof. Examples of organic solvents are C₁₋₄-alkyl acetates, C₁₋₄-alkanols, C₂₋₄-polyols, C₃₋₆-ketones, C₄₋₆-ethers, C₂₋₃-nitriles, nitromethane, dimethylsulfoxide, dimethylformamide, dimethyl-acetamide, N-methylpyrolidone and sulfolane, whereby C₁₋₄-alkanols and C₂₋₄-polyols may be substituted with C₁₋₄-alkoxy. Examples of C₁₋₄-alkyl acetates are methyl acetate, ethyl acetate and propyl acetate, isopropyl acetate and butyl acetate. Other examples include: 2-methoxy-1-methylethyl acetate and 2-ethoxy-1-methylethyl acetate. Examples of C₁₋₄-alkanols are methanol, ethanol, propanol, isopropanol or butanol, isobutanol, sec-butanol and tert-butanol. Other examples of suitable alcohol are aromatic alcohols such as: benzyl alcohol. Examples of a C₁₋₄-alkoxy-derivatives thereof are 2-ethoxyethanol and 1-methoxy-2-propanol. Examples of C₂₋₄-polyols are glycol and glycerol. Examples of C₃₋₆-ketones are acetone, methyl ethyl ketone and cyclic ketones such as: cyclohexanone and lactones such as: 4-butyrolactone. Examples of C₄₋₆-ethers are dimethoxyethane and diisopropylethyl, cyclic ethers such as: tetrahydrofuran, glycol ethers such as diethylene glycol, glycol ether esters and dialkyl glycol ethers. An example of a C₂₋₃-nitrile is acetonitrile. Other solvents include straight, branched and cyclic hydrocarbons including aliphatics such as: heptane, hexane and cyclohexane; and aromatics such as: solvent naphtha (petroleum) light aromatic, toluene, xylenes and ethyl benzene.

More preferably, the solvent is water, a C₁₋₄-alkanol, for example ethanol, a C₁₋₄-alkyl acetate, for example ethyl or propyl acetate, or mixtures thereof, or a C₃₋₆-ketone such as acetone or methyl ethyl ketone.

### Inks

A composition useful in the present invention comprising the dry alpha-AOM and binder can be an ink or surface coating formulation. The ink formulation can be a flexographic, gravure, offset, pad, litho or screen printing ink. The ink formulation can be aqueous or solvent based. Another type of ink that the dry alpha-AOM is particularly suited for are UV flexo inks. These are inks that usually comprise photo-initiators and resins. The substrate coated with a UV flexo ink is exposed to UV light and a chemical reaction takes place during which the photo-initiators cause the ink components to cross-link into a solid, thereby hardening/curing or drying the ink. The ink comprising the dry alpha-AOM can also be electron-beam cured or chemically cured.

The dry alpha-AOM can also be included into a ‘masterbatch concentrate’ formulation from which coating/ink compositions for laser imaging substrates can be subsequently manufactured. Examples of these systems are taught in WO2013/192307.

### Other Additives

The composition comprising dry alpha-AOM and a binder can also comprise other additives. Examples include: polymers, light/energy-absorbing agents, UV-absorbers such as 2-hydroxy-4-methoxybenzophenone, surfactants, waxes, silicones, wetting agents, foam control agents, drying promoters, colourants such as traditional dyes and pigments, fluorescent agents, plasticisers, optical brighteners, oxidizing or reducing agents, stabilizers, light stabilizing agents such as hindered amines, rheology modifiers such as thickening agents such as silica, thinning agents, thixotropy modifiers, dispersing agents, humectants, solvents, adhesion promoters, acid or base-generating agents, acid or base-scavenging agents, opaficiers or retarders.

### Substrates

Substrates can be coated with the compositions comprising AOM described herein. The substrate can be a sheet or any other three-dimensional object and it can be transparent or opaque. The substrate can be cellulose fibre based such as: paper, corrugated fiberboard, cardboard and cartonboard; metal such as a metal container e.g. a can, or metal closure or cap; metallic foil; wood; textiles; leather; glass such as a bottle; ceramics and/or polymers. Examples of polymers are polyethylene terephthalate, low density-polyethylene, polypropylene, biaxially orientated polypropylene, polyether sulfone, polyvinyl chloride, polyester and polystyrene. Preferably, the substrate is made from paper, corrugated fiberboard, cardboard or polymeric film. Also preferably, the substrate is a flexible polymer film made from polyethylene terephthalate, low density-polyethylene, polypropylene, biaxially orientated polypropylene, polyether sulfone, polyvinyl chloride or cellulosic films. The substrate can also be a ridged plastic object, a foodstuff or pharmaceutical preparation.

The thickness of the coating usually chosen is in the range of 0.1 to 1000 microns. Preferably, it is in the range of 1 to 500 microns. More preferably, it is in the range of 1 to 200 microns. Most preferably, it is in the range of 5 to 150 microns.

The substrate can be coated with a composition by using a standard coating application such as a bar coater application, rotation application, spray application, curtain application, dip application, air application, knife application, screen, blade application or roll application.

Where the composition is a liquid ink formulation it can be applied to substrates using any known printing method. Examples include offset, intaglio, flexographic, gravure, UV flexo, pad printing, screen printing and the like.

The coating composition can be dried, for example at ambient or elevated temperature or via energy curing such as UV or electron beam.

As well as being coated on to the surface of a substrate the AOM can also be included within the substrate bulk. Examples include laser imageable paper made by adding the AOM to the paper during its manufacture such as at the sizing stage.

Lasers/Laser systems

The invention encompasses a process for preparing a marked substrate, which comprises the steps of i) coating a substrate with the composition comprising dry AOM and ii) exposing those parts of the coated substrate, where a marking is intended, to energy in order to generate a colour marking.

The energy can be heat or any other energy, which is transformed into heat when applied to the substrate coated with the composition comprising AOM defined herein. Examples of such energy are UV, IR which include near and mid-IR or microwave irradiation.

The energy can be applied to the coated substrate in any suitable way, for example heat can be applied by using a thermal printer, such as those that comprise a thermal print head that contacts the substrate. The energy can also be in the form of electromagnetic radiation or light, preferably in the wavelength range 100 nm to 32 microns. The dry AOM useful in the present invention is particularly effective with laser imaging using 10.6 micron CO₂ lasers. The light can be coherent or non-coherent, broadband or monochromatic. UV, visible and IR irradiation can be applied by using UV, visible or IR light sources such as lamps, bulbs and diodes, or more preferably lasers. Lasers can be pulsed or continuous wave emitters. Examples of IR lasers are CO₂ lasers that emit in the mid-infrared, Nd:YAG or fibre lasers and IR semiconductor lasers that emit in the near infrared. Preferably, the energy is IR irradiation. More preferably, the energy is IR irradiation having a wavelength in the range of 700 nm to 20 microns. Most preferably, the energy is IR irradiation such as that generated by a mid-infrared CO₂ laser or that generated by a near infrared Nd:YAG laser. The most preferred CO₂ laser wavelength is 10.6 microns. Semi-conductor diode lasers also suitable for example: AlGaInP, AlGaAs or InGaAsP based systems. UV laser radiation in the wavelength range 100 nm to 405 nm is also suitable. The light can be emitted from a single source or multiple sources, such as in a diode array, laser array or laser diode array system.

### Other Colour Change Chemistries

The composition useful in the present invention can also comprise other colour change chemistries. Examples include other metal oxyanions, leuco dyes with or without an additional colour developer, charge transfer agents and charrable agents and poly-yne compounds.

### Plastics Imaging

The composition comprising AOM is also particularly suitable for use in the imaging, coding and marking of plastics, particularly with lasers. To do this the dry alpha-AOM is dispersed within the bulk of the plastics. The dry alpha-AOM can be applied to the plastics as a powder, or via a liquid or solid masterbatch. A suitable liquid masterbatch comprises the dry alpha-AOM dissolved, or preferably dispersed, into a polymer compatible liquid vehicle. Suitable liquid vehicles include but are not limited to vegetable or mineral oils. Preferably the liquid vehicle is compatible with both the dry alpha-AOM and the plastics. A suitable solid masterbatch comprises the dry alpha-AOM dissolved, or preferably dispersed in a solid plastics. Plastics suitable for use in preparation of a solid masterbatch comprising dry alpha-AOM include, but are not limited to, carriers such as: HDPE, LDPE, LLDPE, PPHP, PPCP, ABS, SAN, GPPS, HIPS, PC, PA, POM, PMMA, PBT/PET and PVC. The dry alpha-AOM can be applied to plastics in combination with other additives such as colourants, toners, UV absorbers, light stabilizing agents, reheat agents, nucleators, clarifiers, anti-acetaldehyde agents, anti-slip agents, delustrants, pearlescent and metallic effect pigments and oxygen scavengers. The dry alpha-AOM can be applied to the plastic using methods such as injection moulding, blow moulding, profile extrusion, sheet extrusion and film extrusion application methods.

### Energy/Light-Absorbing Agents

The composition comprising AOM can also comprise an energy or light-absorbing agent. These can absorb light in the region 100 nm to 32 microns. Particularly preferred are compounds that absorb in the near infrared region of the spectrum (700 nm to 2500 nm). The compounds are known as NIR absorbers. Any suitable NIR absorber can be used. It is even more preferred still if the absorbance profile or Amax of the NIR absorber approximately matches the emission wavelength(s) of the NIR light source or laser used to image the substrate. Also preferred are NIR absorbers that have negligible impact on the background colour of the substrate. The most preferred NIR absorbers include: 1) inorganic copper salts such as copper (II) hydroxyl phosphate; 2) organic NIR dyes and pigments, such as N,N,N,‘N’-tetrakis(4-dibutylaminophenyl)-p-benzoquinone bis(iminium hexafluoroantimonate); 3) non-stoichiometric inorganic compounds, such as reduced indium tin oxide, reduced zinc oxide, reduced tungsten oxides, metal tungsten bronzes such as cesium tungsten bronze, reduced antimony tin oxide; also included in this are doped metal oxides such as AZO and FTO; and 4) conductive polymers such as PEDOT and the like.

Other energy-absorbing additives include UV absorbers, visible light absorbers and mid-infrared absorbers particularly those that can improve imaging with a CO₂ laser. Examples include mica and mica based compounds such as ATO-coated micas known as Iriodin products.

The following Examples illustrate the invention.

### EXAMPLES

A. Samples of Dry, Alpha AOM

20 batches of dry, alpha-AOM listed below were all prepared by the thermal decomposition of ADM powder in a dryer at 215 to 225° C. for approximately 180 minutes. The LOD values were found to fall in the range 8.32 to 8.57 as follows:

| Batch | LOD |
|---|---|
| 1 | 8.32 |
| 2 | 8.34 |
| 3 | 8.33 |
| 4 | 8.35 |
| 5 | 8.36 |
| 6 | 8.37 |
| 7 | 8.37 |
| 8 | 8.38 |
| 9 | 8.40 |
| 10 | 8.45 |
| 11 | 8.47 |
| 12 | 8.48 |
| 13 | 8.49 |
| 14 | 8.51 |
| 15 | 8.52 |
| 16 | 8.54 |
| 17 | 8.54 |
| 18 | 8.55 |
| 19 | 8.56 |
| 20 | 8.57 |

Also for comparison the following samples of dry alpha-AOM were also prepared with LOD values outside of this range.

| Batch | LOD |
|---|---|
| 21 | 7.97 = Prepared by heating ADM at 225° C. for 240 minutes. |
| 22 | 8.85 = Prepared by heating ADM at 200° C. for 120 minutes. |

### 1. Ink Formulation and Laser Imaging Performance

Each dry alpha-AOM sample was made into an aqueous based liquid ink formulation as follows:

| | | |
|---|---|---|
| 1. | Aqueous acrylic binder emulsion | 26.5% |
| 2. | Aqueous emulsion of monoethanolamine salt of a | 13.5% |
| | carboxylated acrylic copolymer | |
| 3. | Mineral oil based anti-foaming agent | 1.5% |
| 4. | Diethylene glycol | 2.0% |
| 5. | Aqueous titanium complex solution | 1.5% |
| 6. | Dry alpha-AOM powder sample | 55% |

Each ink was mixed using a Silverson disperser to achieve a Hegmann grind gauge particle size of <5 microns.

Each ink was applied to brown kraft paper using the same flexographic printing technique.

The coated papers were then imaged using a 30W CO₂ laser, emitting at a wavelength of 10.6 microns. In each case a 1 cm² square was imaged at fluence of 2.8 Jcm⁻² and the resultant optical density measuring using a Gregtag-MacBeth SpectroEye 5000 spectrophotometer (D65, 2°). This generated LOD versus optical density data.

### Results

| | LOD | 5 gsm, 2.8 J/cm² ODB |
|---|---|---|
| Sample 1 | 8.32 | 1.31 |
| Sample 2 | 8.34 | 1.30 |
| Sample 3 | 8.33 | 1.29 |
| Sample 4 | 8.35 | 1.30 |
| Sample 5 | 8.36 | 1.23 |
| Sample 6 | 8.37 | 1.22 |
| Sample 7 | 8.37 | 1.23 |
| Sample 8 | 8.38 | 1.19 |
| Sample 9 | 8.40 | 1.16 |
| Sample 10 | 8.45 | 1.11 |
| Sample 11 | 8.47 | 1.07 |
| Sample 12 | 8.48 | 1.12 |
| Sample 13 | 8.49 | 1.10 |
| Sample 14 | 8.51 | 1.10 |
| Sample 15 | 8.52 | 1.02 |
| Sample 16 | 8.54 | 1.02 |
| Sample 17 | 8.54 | 1.03 |
| Sample 18 | 8.55 | 1.07 |
| Sample 19 | 8.56 | 1.00 |
| Sample 20 | 8.57 | 1.00 |
| Also | | |
| Sample 21 | 7.97 | Not determined - see below |
| Sample 22 | 8.85 | 0.55 |

It can be seen that a general trend of decreasing ODB with increasing LOD can be seen. A sample with an LOD=8.85 gave an OBD=0.55. Such an ODB would be too low for applications requiring readable codes and information.

### 2. AOM Powder and Ink Colour

Sample 21 (LOD=7.97) appeared discoloured. It had a visibly noticeable off-white blue/grey colour. This sample subsequently gave rise to an ink with an off-white blue/grey appearance and this ink also gave rise to a coated patch on a white substrate with a noticeable off-white blue/grey colour.

All the other inks and coatings prepared with samples 1 to 20 were white in appearance.

### Comparative Example 1

### Dry Alpha-AOM Versus Wet X-AOM

A sample of dry alpha-AOM having a LOD=8.39 was compared with a sample of wet X-AOM that had an LOD=8.41. The wet X-AOM had been prepared using the aqueous slurry based or wet route, as disclosed in U.S. Pat. No. 4,762,700 and U.S. Pat. No. 6,235,261.

Both AOM samples were formulated into a solvent based ink as follows:

| | |
|---|---|
| Elvacite 2028 | 15% |
| AOM powder sample | 30% |
| Denatured Ethanol B 100/Ethyl acetate (3:1) | 55% |

Each ink was prepared using a Silverson mixer and had a final particle size distribution of <5 microns as measured on a Hegmann gauge.

Both inks were drawn down, on to 50 micron, white PET film using an RK K Control Coater fitted with the same meter bar. The coated substrates were then imaged using a 30W CO₂ laser. In each case a 1 cm² square was imaged at fluence of 2.8 Jcm⁻² and the resultant optical density measuring using a Gregtag-MacBeth SpectroEye spectrophotometer (D65, 2° observer).

### Results

| | |
|---|---|
| Dry alpha-AOM with LOD = 8.39 | ODB = 1.03 |
| Wet X-AOM with LOD = 8.39 | ODB = 0.28 |

This shows the greater laser imaging efficacy of dry alpha-AOM over wet X-AOM with similar LODs.

### Comparative Example 2

### Dry Alpha-AOM Versus Wet X-AOM in a UV Flexo

The same samples of dry alpha-AOM versus wet X-AOM used in Comparative example 1 were used.

The following UV Flexo formulation was created.

| | |
|---|---|
| Laromer PO33F | 34.8% |
| AOM sample | 26.2% |
| Laromer LR9013 | 20.2% |
| Tripropyleneglycol diacrylate | 16.3% |
| Irgacure 1173 | 2.5% |

Laromer and Irgacure products are ex. BASF.

The inks were applied to a 50 micron white PET film using a flexographic printing process and cured using a Jenton UV curing conveyor machine.

The coatings were then imaged using a CO2 laser.

Dry alpha-AOM with LOD=8.39 ODB=0.81

Wet X-AOM with LOD=8.39 ODB=0.19

### Comparative Example 3

### Dry Alpha-AOM Versus Wet X-AOM in Plastics Marking

The same samples of dry alpha-AOM versus wet X-AOM used in Comparative example 1 were used.

Each sample of AOM was melt processed into a high density polyethylene resin, at a weight loading of 3%, using an injection moulding machine set with a barrel temperature of 190° C. A plaque of dimension 55 mm×30 mm of dual thickness, 2 and 4 mm was produced.

The plaques were imaged using a 30W CO2 laser.

The dry alpha-AOM based plaques produced a black easily human readable code. In contrast, the X-AOM based plaques produced a faint light grey, barely readable code.

1. A method for providing an image on or in a substrate, the method comprising:
applying to the substrate:
(i) ammonium octamolybdate (AOM) in the form of the alpha-isomer, obtainable by thermal decomposition of ammonium molybdate at a temperature in a range of 215-225° C. for 180 mins, and which has an anhydrous loss on ignition in a range of 8.00 to 8.80; or
(ii) a composition comprising ammonium octamolybdate as defined in (i), and
a binder;
followed by irradiation.

2. The method as claimed in claim 1, wherein the anhydrous loss on ignition is in a range of 8.20 to 8.50.

3. The method as claimed in claim 1, wherein the anhydrous loss on ignition is in a range of 8.22 to 8.40.

4. The method as claimed in claim 1, wherein the anhydrous loss on ignition is in a range of 8.24 to 8.38.

5. The method as claimed in claim 1, wherein the anhydrous loss on ignition is in a range of 8.30 to 8.35.

6. The method as claimed in claim 1, wherein the ammonium octamolybdate is in the form of the dry alpha-isomer.

7. The method according to claim 1, wherein the composition is a liquid ink formulation.

8. The method as claimed in claim 1, wherein the composition is an aqueous, screen, pad, solvent, or a UV flexo liquid ink formulation.

9. The method according to claim 1, wherein the composition further comprises a radiation-absorbing agent.

10. The method as claimed in claim 9, wherein the radiation-absorbing agent absorbs radiation in a wavelength range of 100 nm to 32 microns.

11. The method according to claim 1, wherein the composition comprises an additional colour-forming agent.

12. The method according to claim 1, wherein the irradiation is in a wavelength range of 100 nm to 32 microns, and preferably has a wavelength of 10.6 microns.

13. The method as claimed in claim 1, wherein the irradiation is provided by a laser or an array of laser sources.

14. The method as claimed in claim 13, wherein the laser irradiation is provided by a CO₂ laser.

15. The method as claimed in claim 13, wherein the laser irradiation is provided by a Nd:YAG laser.

16. The method as claimed in claim 13, wherein the laser irradiation is provided by a semi-conductor diode laser.

17. The method according to claim 1, wherein the substrate is selected from paper, corrugated fiberboard, plastics film, rigid plastic, textiles, glass, metal, foil, foodstuffs, and pharmaceutical preparations.

18. The method according to claim 1 for preparing a marked substrate, the method comprising the steps of coating a substrate with the composition comprising AOM as defined in (i) and a binder; and exposing those parts of the coated substrate to energy in order to generate a colour marking.

19. A liquid ink composition for use in image formation, the liquid ink composition comprising: ammonium octamolybdate in the form of the alpha-isomer, obtainable by thermal decomposition of ammonium molybdate at a temperature in a range of 215-225° C. for 180 mins, and which has an anhydrous loss on ignition in a range of 8.00 to 8.80; and a binder.

20. The liquid ink composition according to claim 19, which is an aqueous, screen, pad, solvent or a UV flexo liquid ink formulation.

21. The liquid ink composition according to claim 19, wherein the composition further comprises a radiation-absorbing agent.

22. The liquid ink composition according to claim 21, wherein the radiation-absorbing agent absorbs radiation in a wavelength range of 100 nm to 32 microns.

23. The liquid ink composition according to claim 19, wherein the composition further comprises an additional colour-forming agent.
